(19) United States
(12) Patent Application Publication
(10) Pub. No.: US 2024/0429705 A1
(43) Pub. Date: Dec. 26, 2024

(54) VERTICAL THYRISTOR SWITCH FOR CONTROLLABLE SURGE ARRESTER

(71) Applicants: GLOBAL ENERGY INTERCONNECTION RESEARCH INSTITUTE CO., LTD., Beijing (CN); STATE GRID SHANGHAI MUNICIPAL ELECTRIC POWER COMPANY, Shanghai (CN); STATE GRID CORPORATION OF CHINA, Beijing (CN)

(72) Inventors: Guoliang ZHAO, Beijing (CN); Weiguo LI, Beijing (CN); Qiuyu SHI, Beijing (CN); Xianshan GUO, Beijing (CN); Guangyao QIAO, Beijing (CN); Fangyi LI, Beijing (CN); Yunfei XU, Beijing (CN); Haijun LIU, Beijing (CN); Yanjiao JIN, Beijing (CN); Zhe CHENG, Beijing (CN)

(73) Assignees: GLOBAL ENERGY INTERCONNECTION RESEARCH INSTITUTE CO., LTD., Beijing (CN); STATE GRID SHANGHAI MUNICIPAL ELECTRIC POWER COMPANY, Shanghai (CN); STATE GRID CORPORATION OF CHINA, Beijing (CN)

(21) Appl. No.: 18/825,497

(22) Filed: Sep. 5, 2024

Related U.S. Application Data
(63) Continuation of application No. PCT/CN2021/115719, filed on Aug. 31, 2021.

(30) Foreign Application Priority Data
Oct. 27, 2020 (CN) 202011163181.1

(51) Int. Cl. H02H 9/04

(52) U.S. Cl. CPC H02H 9/041; H02H 9/044

(57) ABSTRACT

A vertical thyristor switch for a controllable surge arrester includes an insulating sleeve and a vertical cylindrical switch core body encapsulated inside the insulating sleeve. The switch core body includes thyristor valve sections, a reactor, driving units, a voltage equalizing assembly section, a structural member and a connecting member; and after being connected to the driving units on one side of the thyristor valve sections, the thyristor valve sections are arranged, together with the voltage equalizing assembly section, in a space of a lower section of the structural member, an upper section of the structural member is provided with the reactor, and components inside the switch core body are electrically connected through the connecting member.

### CROSS-REFERENCE TO RELATED APPLICATIONS

This application is a continuation of International Application No. PCT/CN2021/115719 filed on Aug. 31, 2021, which claims priority to Chinese Patent Application No. 202011163181.1 filed on Oct. 27, 2020. The disclosures of the above-referenced applications are hereby incorporated by reference in their entirety.

### BACKGROUND

The EHV/UHV power transmission using a voltage equal to or greater than 750 kV has technical advantages, such as, large transmission capacity, long power transmission distance, high efficiency and low loss; and is widely used in scenarios, such as, cross-regional power grid interconnection and long-distance power transmission. In an EHV/UHV power transmission system, as the voltage level increases, a switching impulse sparkover voltage of an air gap will have more apparent saturation characteristics. Reducing a level of the switching overvoltage plays a critical role in reducing the air gap of the line and the power transmission corridor, and may effectively reduce the difficulty and cost of the insulation design of the power transmission and transformation equipment. Therefore, as the power transmission voltage level increases, greatly reducing the level of the switching overvoltage has great significance to reduce the clearance distance of the power transmission line, reduce the power transmission corridor, reduce the cost of the equipment, and improve insulation safety margin of the system.

In the EHV/UHV AC system with the voltage equal to or greater than 750 kV, the switching overvoltage will be generated in the procedures of the transmission line switching, the grounding fault, and the load rejection. For this reason, the existing conventional solution is the joint use of two measures, i.e., a metal oxide surge arrester and a circuit breaker provided with a closing resistor, to limit the switching overvoltage of the system to a certain level (where for a system with the voltage of 750 kV, the switching overvoltage is limited to be lower than 1.8 per unit (p.u.), and for a system with the voltage of 1000 kV, the switching overvoltage is limited to have a range from 1.6 p.u. to 1.7 p.u. By providing the closing resistor in the circuit breaker, the power of the power grid generated during the opening and closing process is released, thereby reducing the level of the switching overvoltage and protecting the power grid equipment. However, the closing resistor has significant shortcomings in terms of operating reliability, economy and area occupied, thus the circuit breaker provided with the closing resistor is mechanically complex, which greatly increases the operating risk of the circuit breaker. Moreover, the circuit breaker provided with the closing resistor involves a large increase in the equipment cost. Therefore, the power system operating department and the manufacturer tend not to provide the closing resistor in the circuit breaker in the case where system conditions permit.

Another solution for greatly limiting the switching overvoltage is to use the metal oxide controllable surge arrester (also known as the metal zinc oxide surge arrester) that has the ideal nonlinear resistance characteristics. Under the normal operating voltage of the system, the resistance of the metal oxide controllable surge arrester is very large, the leakage current passing through it is very small, and the resistive component is only about 10 micro ampere (uA) to 15 uA. Such a small current will not affect the life of the valve plate. When the voltage increases, the resistance of the metal oxide controllable surge arrester becomes very small, the current passing through it is large, and the residual voltage is also low, so that the electrical equipment is protected. After the overvoltage disappears, the metal oxide controllable surge arrester enters current low-current region and returns to a high-resistance state.

In the metal oxide controllable surge arrester, one by-pass switch that can be flexibly controlled is connected in parallel with part of sheet-type resistors of the existing EHV/UHV surge arrester. Under the overvoltage, the by-pass switch is turned on to short-circuit a part of the sheet-type resistors of the zinc oxide surge arrester, so as to greatly reduce the residual voltage. After the overvoltage disappears, the by-pass switch is turned off, and the sheet-type resistors of the zinc oxide surge arrester that are short-circuited operate again to withstand the power frequency voltage and maintain a low chargeability of the surge arrester. According to a type of the by-pass switch, the metal oxide controllable surge arrester may be categorized into a circuit-breaker-switched controllable surge arrester and a thyristor-switched controllable surge arrester. Due to the slow operation speed of the circuit breaker switch (generally more than 30 ms), the by-pass circuit breaker in the controllable surge arrester is required to be put into the controllable surge arrester before the line is closed, which may only limit the closing overvoltage, and the circuit breaker switch needs to be used together with a station control system. Therefore, the application effect of the circuit-breaker-switched controllable surge arrester is greatly limited. The thyristor-switched controllable surge arrester makes full use of characteristics of the thyristor device, such as fast response speed, being turned on automatically upon the trigger of the positive overvoltage, being turned off in response to the current zero crossing, etc. The thyristor-switched controllable surge arrester is able to operate independently and control a high-voltage switch by means of a low-voltage device; has fast operation speed (less than 5 μs); does not need the complex secondary system; and has the response characteristics same as the surge arrester. Therefore, the thyristor-switched controllable surge arrester is an important direction of future development.

As the installation height of the UHV/UHV arrester increases and the number of sheet-type resistors connected in series under high voltage increases, the potential distribution of the sheet-type resistors of the arrester will tend to be more non-uniform due to the influence of the distributed capacitance. In order to facilitate installation and maintenance and reduce the floorage, the thyristor switch in the thyristor-switched controllable surge arrester is required to be connected in parallel with the surge arrester body and installed vertically, and the closer the distance to the surge arrester, the smaller the influence on the potential distribution of the body. The thyristor-switched controllable surge arrester is required to operate in an outdoor environment. The height of the structure of the thyristor switch and the internal distributed capacitance of the thyristor switch have an influence on the potential distribution of the surge arrester body, which needs to be strictly limited. Therefore, the thyristor-switched controllable surge arrester is required to have characteristics of compact structure, easy to be expanded and small leakage current.

Most of the existing thyristor valves used in the fields, such as Static Var Compensator (SVC), High Voltage Direct Current (HVDC) transmission, have the horizontal structure, and are affected by the cooling requirement, the complex absorption circuits, the voltage equalizing circuit and the control system. Therefore, the thyristor valve has a complex structure, a large floorage and a leakage current far greater than the limitation of surge arrester; is limited to operate in the indoor environment; and is not suitable for use in an application scenario of the controllable surge arrester.

Therefore, the study of a compact vertical thyristor switch suitable for use in outdoors is a technical problem urgently needed to be overcome in the design of a controllable surge arrester. The present disclosure provides a compact vertical thyristor switch suitable for applying to a controllable surge arrester.

### SUMMARY

The present disclosure belongs to the field of Extra High Voltage (EHV)/Ultra High Voltage (UHV) power transmission, and in particular to, a thyristor switch for a controllable surge arrester.

The embodiments of the present disclosure provide a vertical thyristor switch for a controllable surge arrester, including: an insulating sleeve and a vertical switch core body encapsulated inside the insulating sleeve. The switch core body includes thyristor valve string sections, a reactor, driving units, a voltage equalizing assembly section, a structural member and a connecting member; after being connected to the driving units on one side of the thyristor valve string sections, the thyristor valve string sections are arranged, together with the voltage equalizing assembly section, in a space of a lower section of the structural member, an upper section of the structural member is provided with the reactor, and components inside the switch core body are electrically connected through the connecting member.

### BRIEF DESCRIPTION OF THE DRAWINGS

FIG. 1 is a schematic integral structural diagram of a vertical thyristor switch for a controllable surge arrester according to an embodiment of the present disclosure.

FIG. 2 is a schematic structural diagram of an insulating sleeve according to an embodiment of the present disclosure.

FIG. 3 is a schematic structural diagram of thyristor valve string sections according to an embodiment of the present disclosure.

FIG. 4 is a schematic diagram of umbrella skirt structures of a saturable reactor according to an embodiment of the present disclosure.

FIG. 5 is a schematic diagram of an outlet structure of a saturable reactor according to an embodiment of the present disclosure.

FIG. 6 is a schematic diagram of an Explosive Ordnance Disposal (EOD) structure at a bottom plate according to an embodiment of the present disclosure.

### DETAILED DESCRIPTION

Due to the slow operation speed of the circuit breaker switch, the existing circuit-breaker-switched controllable surge arrester may only limit the closing overvoltage, and needs to be used together with the station control system, and the application scenarios are greatly limited. The thyristor-switched controllable surge arrester has fast response time, is able to operate independently; does not need the complex secondary system, and has the response characteristics same as the surge arrester. In order to control the influence of the height of the thyristor switch and the distributed capacitance on the potential distribution of the surge arrester body, a well integration of the thyristor switch and the surge arrester body is required to be implement.

In order to solve the above problem, and to solve the problems that the existing thyristor switch cannot be well integrated with the surge arrester body, occupies a large area, is not easy to be expanded, has a large partial discharge level, is not suitable for operating in outdoors, and has a large leakage current, the embodiments of the present disclosure provide a vertical compact thyristor switch for the controllable surge arrester. By installing the controllable surge arrester on the side of a transformer station line, the switching overvoltage is greatly reduced.

The vertical thyristor switch for a controllable surge arrester includes vertical thyristor valve string sections, a reactor 3, driving units, a voltage equalizing assembly section 2, an insulating sleeve 4, structural members and connecting members between various components. The vertical thyristor valve sections, the reactor 3, the driving units, the voltage equalizing assembly section 2 and the connecting members constitute the core body of the thyristor switch, and the core body is integrally encapsulated inside the insulating sleeve 4. The thyristor valve string section is formed by clamping multiple layers of anti-parallel thyristor devices 24. The whole thyristor switch may include multiple valve sections connected in series according to the requirement of voltage, and the structure of the whole thyristor switch may be flexibly expanded. In the switch core body, the reactor 3 is connected in series to the thyristor valve section 1 through the structural member and the connecting member. The switch core body is arranged into an airtight insulating sleeve as a whole, which has the characteristics of compact structure, easy to be expanded, small partial discharge, small leakage current, and suitable for operating in outdoor.

In order to make the purpose, technical schemes and advantages of the embodiments of the present disclosure more clear, the technical schemes of the embodiments of the present disclosure will be clearly described in the following with reference to the drawings in the embodiments of the present disclosure.

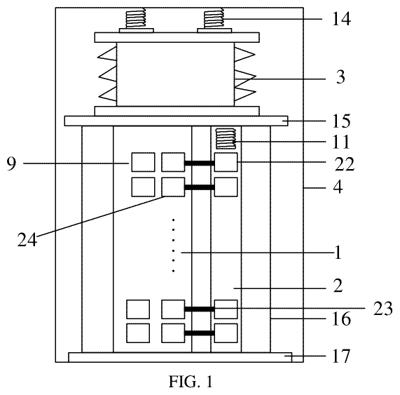

As shown in FIG. 1, the embodiments of the present disclosure provide a vertical thyristor switch for a controllable surge arrester, including: an insulating sleeve 4 and a vertical cylindrical switch core encapsulated inside the insulating sleeve 4. The switch core body includes thyristor valve string sections, a reactor 3, driving units, a voltage equalizing assembly section 2, a structural member and a connecting member. After being connected to the driving units on one side of the thyristor valve string sections, the thyristor valve string sections are respectively arranged, together with the voltage equalizing assembly section 2, in a space of a lower section of the structural member. The upper section of the structural member is provided with the reactor 3. The components inside the switch core body are electrically connected through the connecting member.

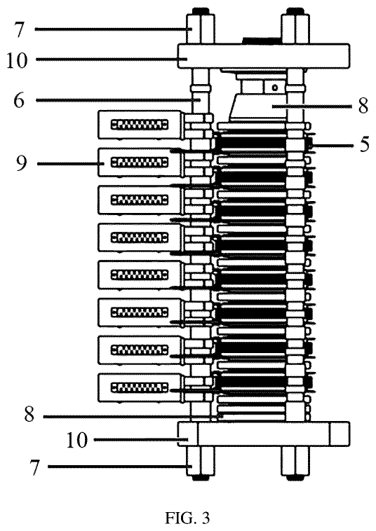

In the embodiment of the present disclosure, as shown in FIG. 1 and FIG. 3, the thyristor valve string section includes: a thyristor device 24 composed of multiple layers of thyristors 5 connected in anti-parallel, a jacking tie bar 6, a jacking nut 7, and a jacking end plate 10. With the increase of the voltage of the controllable part of the surge arrester, the number of layers of thyristors required to be connected in series will increase. The number of layers of thyristor devices 24 connected in series may be flexibly determined according to the voltage withstood by the thyristor switch.

The thyristor devices 24 are clamped, through the jacking tie bar 6 and the jacking nut 7, to form multiple thyristor valve sections 1, and the multiple thyristor valve sections 1 are connected in series from top and bottom to form multiple valve strings. The whole thyristor switch may be formed by multiple thyristor valve sections 1 connected in series from top and bottom. The jacking end plates 10 are used as a transition connection between the multiple thyristor valve sections 1. A stacked opposite triangle structure is formed through connection of the jacking end plates 10 at a top and/or a bottom within the thyristor valve string. In this way, the space required for the connection between the thyristor valve section 1, the valve string, and the valve string section is reduced. Moreover, the jacking end plates are used as the transition connection between multiple valve sections, which effectively reduces the height of the thyristor valve section.

In the embodiment of the present disclosure, the jacking end plate 10 includes multiple opposite triangle structures, and each opposite triangle structure fixes one string section. The structure space occupied by the opposite triangle structure is small, and more string section structures can be arranged and installed in a limited space. The stacked opposite triangle arrangement is adopted through the jacking end plates 10, which effectively reduces the height of the thyristor valve section, effectively improve the utilization rate of the space of the core switch, and reduce the overall height of the switch core.

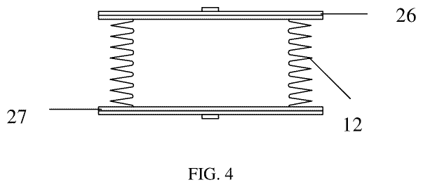

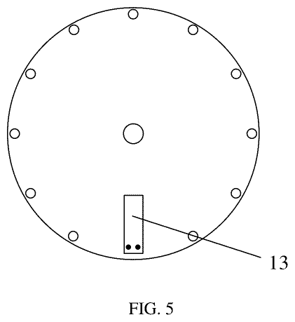

In the embodiment of the present disclosure, as shown in FIG. 1, FIG. 4 and FIG. 5, the reactor 3 adopts a cylindrical structure, and is a self-cooled saturable reactor. In the switch core body, the self-cooled saturable reactor is connected in series to the thyristor valve section 1 through the structural member and the connecting member. A top and/or bottom of the self-cooled saturable reactor 3 adopt a press fit outlet line and/or an external connection. Furthermore, this manner of the outlet line may adopt an aluminum bar outlet line structure 13. A pressure contact structure is adopted between the outlet line structure and the top and bottom parts, and additional wiring is not required to be configured, and the structure is compact. An external periphery of the reactor is provided with first umbrella skirt structures 12, and then in the case where the creepage distance is guaranteed or the creepage distance of the reactor is increased, the height of the saturable reactor can be effectively reduced.

The self-cooled saturable reactor is integrally cast to implement internal insulation. Through the optimized design of the cylindrical structure, the uneven distribution of the electric field around the reactor 3 is effectively overcome, and the height of the reactor 3 is effectively reduced in the case where ensuring the same creepage distance. Through the top and/or bottom of the reactor 3 adopting the press fit outlet line and/or the external connection, the space for bolts or welding and other redundant wiring is saved, which makes the spatial structure of the reactor 3 to be more reasonable; and in combination with the umbrella skirt structures 12 arranged on external periphery of the reactor, the creepage distance of the reactor is increased, the height of the reactor can be effectively reduced, and thereby reducing the overall height of the switch.

In the embodiment of the present disclosure, the first umbrella skirt structure 12 is a cylindrical body, and a side surface of the cylindrical body is provided with protruding umbrella skirt structures having umbrella skirts facing outwards; and the a top plate 26 and a bottom plate 27 of the reactor 3 are respectively arranged at a top end and a bottom end of the side surface of the cylindrical body, which further optimizes the effect of the creepage distance of the reactor and reduces the height of the reactor.

In the embodiment of the present disclosure, the driving unit includes multiple driving assemblies 9 each adopting a pluggable fixed structure, and two thyristors connected in anti-parallel at each layer share a group of driving assemblies 9. By configuring one driving assembly at each layer and configuring that the thyristors 5 connected in anti-parallel share one group of driving assemblies, the utilization efficiency of the driving assemblies 9 is improved, the effect of the driving performance of the driving assemblies is enhanced, the number of driving board cards can be reduced by half, and the volume of the switch core body can be reduced.

For example, the driving assembly is a passive driving assembly, and an operation time of the driving assembly has a range from 1 microsecond (μs) to 10 μs.

In the embodiment of the present disclosure, the pluggable fixed structure is a drawer structure, which is convenient for overhaul and maintenance under the condition that the connection is fastened, and is convenient and practical.

In an embodiment of the present disclosure, the voltage equalizing assembly section 2 includes a voltage equalizing assembly, a metal pad, and a top damping spring of the voltage equalizing assembly 11.

The voltage equalizing assemblies are connected, through electrical connection structural members 23 in the connecting member, to respective layers of the thyristor devices 24 of the thyristor valve string section, and a top of the voltage equalizing assemblies is connected to the top damping spring 11 of the voltage equalizing assembly. The top pressure contact is not required for the voltage equalizing assembly, but considering the influence of vibration during operation, transportation and earthquake, the top damping spring 11 of the voltage equalizing assembly is added on the top of the voltage equalizing assembly section. The number of the top damping springs is determined according to the height and the weight of the core body, to absorb vibration during the operation or the transportation.

In the embodiment of the present disclosure, the voltage equalizing assembly includes multiple stacked voltage equalizing elements 22 that are connected in series. The number of voltage equalizing elements 22 connected in corresponds to the number of thyristor devices 24 connected in series.

The connecting member includes metal members, a number of which is same as a number of the voltage equalizing elements 22 and/or having the cross area equal to the cross area of the voltage equalizing elements 22. Each of the metal members may be metal pad or other metal structures having the function of the metal pad, and the voltage equalizing element 22 at each layer is connected, through the electrical connecting structure of one metal member (i.e., one metal pad), to a single layer within the thyristor valve string section, so as to implement the parallel connection with the thyristor device 24 at a respective layer.

Exemplarily, in some embodiments, the voltage equalizing assembly includes only a nonlinear sheet-type resistor.

It is to be understood that the small-capacity voltage equalizing capacitor may also be flexibly arranged in the voltage equalizing assembly according to requirements, to improve the voltage equalizing performance of the thyristor switch and reduce the leakage current of the switch. For example, in other embodiments, the voltage equalizing assembly includes the nonlinear sheet-type resistor and a small-capacity voltage equalizing capacitor, where a capacitance of the small-capacity voltage equalizing capacitor is determined according to a potential distribution requirement and a leakage current limiting condition. For example, the capacitance has a range from 10 pico farad (PF) to 999 PF. The voltage equalizing capacitor is mounted in the connecting member between the voltage equalizing assembly and the thyristor device 24. At a normal operating voltage, a leakage current from both the voltage equalizing assembly and the thyristor device 24 is less than 5 mA.

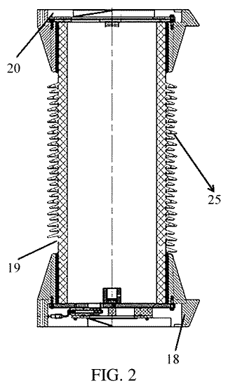

In the embodiment of the present disclosure, as shown in FIG. 1 to FIG. 2, the insulating sleeve 4 includes a bottom flange 18, an intermediate insulating member 19, and a top flange 20. The bottom flange 18 and the top flange 20 are respectively arranged at the top end and the bottom end of the intermediate insulating member 19. The top damping spring 14 of the core body is connected to the top inner surface of the top flange 20, and top damping spring 14 of the core body is arranged to absorb the vibration during transportation, installation and outdoor earthquake and improve the anti-earthquake capability of the switch core.

In the embodiment of the present disclosure, the inside of the thyristor switch is the switch core body, and the outside of the thyristor switch is the insulating sleeve 4. The switch core body is fixed in the insulating sleeve 4. The insulating sleeve 4 is an external insulating structure with an inner diameter set according to the size of the switch core body, and a space for installing is considered. An expansion space is reserved, according to a requirement, inside the insulating sleeve 4, and the insulating sleeve 4 is filled with nitrogen to make the core body in a gas insulating environment, and the insulating sleeve is airtight as a whole. The switch is transported, installed and implements functions as a whole, and the switch is suitable for operating in outdoors.

In the embodiment of the present disclosure, the intermediate insulating member 19 adopts a cylindrical structure, and is formed using a porcelain material or a composite material. Furthermore, the cylindrical structure may use the porcelain sleeve or the composite insulating sleeve, and the intermediate insulating member 19 may be formed using a porcelain material or a composite material. The second umbrella skirt structures 25 having unequal heights are distributed on a surface of the intermediate insulating member 19, and the second umbrella skirt structures 25 may affect the surface electric field and charge distribution of the intermediate insulating member 19.

In the embodiment of the present disclosure, as shown in FIG. 3, in order to ensure that the pressure on each of the clamping surface of the thyristor devices 24 is uniform, a force balancing mechanism is also arranged inside the valve string, and a force balancing mechanism 8 is provided between the bottom of the valve string and the jacking end plate 10.

In the embodiment of the present disclosure, the structural member includes: the top damping spring 14 of the core body, a mid-layer connecting plate 15, anti-pressure supporting beams 16 and a lower supporting plat 17.

The anti-pressure supporting beams 16 are arranged around the thyristor valve string section and the voltage equalizing assembly section 2, and have a height greater than a height of the thyristor valve string section and a height of the voltage equalizing assembly section 2.

In order to reduce the influence of pressure of the top damping spring 14 of the core body on the pressure of the thyristor valve string section at the bottom. The lower supporting plate 17 and the mid-layer connecting plate 15 that are horizontal are respectively arranged at top ends and bottom ends of the anti-pressure supporting beams 16.

The bottom ends of the anti-pressure supporting beams 16 are connected to an upper surface of the horizontal lower supporting plate 17, and the top ends of the anti-pressure supporting beams 16 are connected to a lower surface of the horizontal mid-layer connecting plate 15.

The reactor 3 is arranged on an upper surface of the mid-layer connecting plate 15, and a top end of the reactor 3 is connected to the insulating sleeve 4 through the top damping springs of the core body. The horizontal mid-layer connecting plate 15 and the anti-pressure supporting beams 16 are arranged in the switch core body to form a supporting structure for multiple valve sections of the switch core body, so as to implement the isolation of the switch core body from the vertical thyristor valve section 1 under the pressure of the top spring.

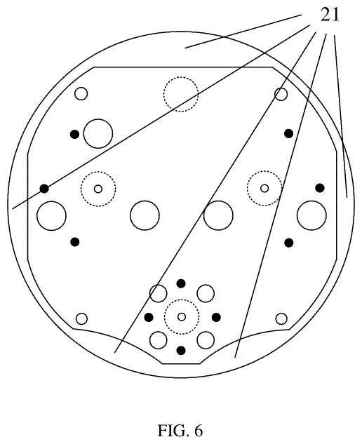

In the embodiment of the present disclosure, as shown in FIG. 1 and FIG. 6, the lower supporting plate 17 adopts a plate-like structure and is located at a bottom of the switch core body, and form a special-shaped structure through staggered stacking; and holes 21 are distributed on the lower supporting plate 17; and a gap is provided between the lower supporting plate 17 and the insulating sleeve 4.

In the embodiment of the present disclosure, the voltage sheet-type equalizing resistor as well as the voltage equalizing capacitor are configured in one-to-one correspondence with the thyristor 5, and the voltage equalizing capacitor is installed between two metal busbars, which reduces the space occupied by the voltage equalizing assembly and improves the integration and compactness of the whole switch.

In order to meet the explosion-proof requirement for the airtight space of the porcelain sleeve, sufficient explosive EOD channels are reserved on the lower supporting plates 17 of the switch core. The hole 21 of the lower supporting plate 17 and the gap form an EOD channel for electric spark and nitrogen, and the discharge port of the EOD channel faces the bottom flange 18, which meets the explosion-proof requirement for the insulating sleeve.

The technical schemes of the embodiments of the present disclosure as a whole include at least the following beneficial effects.

1. The embodiments of the present disclosure provide a compact structure of a vertical thyristor switch for a controllable surge arrester. The compact structure has characteristics of suitable for operating in outdoors, being flexibly expanded according to the requirement of the voltage, effectively reducing the height of the thyristor switch, and reducing the influence on the potential distribution of the surge arrester body.

2. The embodiments of the present disclosure provide a self-cooled saturable reactor 3 structure, which adopts the a press fit outlet line and an external connection on the top and/or bottom, so as to avoid the influence on partial discharge and potential distribution caused by increasing auxiliary wiring and fixing bolts. The insulating umbrella skirts 12 are arranged on the external periphery of the saturable reactor, which can effectively reduce the height of the saturable reactor 3 and the overall height of the thyristor switch in the case where the creepage distance is satisfied. Furthermore, the structure is compact.

3. The driving assembly 9 having the pluggable structure proposed by the embodiments of the present disclosure is convenient for overhaul and maintenance. Furthermore, the two thyristors connected in anti-parallel share one driving assembly, which reduces the complexity of the equipment, reduces the dispersion of the operation, and can effectively improve the compactness of the switch.

4. In the embodiments of the present disclosure, the multiple sections of the thyristor valve strings are stacked and arranged as opposite triangle, which can effectively improve the utilization rate of the space, reduce the overall height and diameter of the core body, and reduce the volume of the switch.

5. The encapsulation manner of the insulating porcelain sleeve or composite insulating sleeve proposed in the embodiments of the present disclosure is suitable for operating in outdoors, and is designed with the EOD channel suitable for the airtight space of the insulating sleeve 4, which meets the explosion-proof requirement for in the insulating sleeve 4.

6. The top damping spring 14 of the core body and anti-pressure supporting beams 16 proposed by the embodiments of the present disclosure are adapted to the overall transportation of the switch, meet the anti-earthquake requirement for the switch, and ensure the uniformity of the pressure on the vertical clamped thyristor.

7. The switch adopts a cylindrical structure as a whole. Through the optimized design, the partial discharge of the switch is less than 2 picoCoulomb (pC) under the voltage when the switch continuous operating.

8. The small voltage equalizing capacitor and/or the nonlinear sheet-type resistor are used for the voltage equalizing and protection of the thyristor device 24, and interlayer busbars are used for implement the electrical connection when multiple layers of the thyristor devices are connected in parallel. This method the makes the leakage current of the switch less than 5 mA under the premise of ensuring that the effect of the voltage equalizing, which can be applied to surge arresters and other occasions that require strict leakage current. Moreover, the volume of the switch is greatly reduced by designing the structures of the voltage equalizing assembly and the thyristor devices 24 to be very tight.

It is apparent that the described embodiments are a part of the embodiments of the application, not all of the embodiments. Based on the embodiments in the application, all other embodiments obtained by those skilled in the art without creative effort belong to the protection scope of the application.

The special term “exemplary” refers to “use as an example, embodiment or description”. Herein, any “exemplarily” described embodiment may not be explained to be superior to or better than other embodiments. Although each aspect of the embodiments is shown in the drawings, the drawings are not required to be drawn to scale, unless otherwise specified.

The above descriptions are only exemplary embodiments of the present disclosure and are not intended to limit the present disclosure. Any modification, equivalent replacement, improvement, etc. made within the spirit and principles of the present disclosure shall be included in the scope of protection of the present disclosure.

1. A vertical thyristor switch for a controllable surge arrester, comprising an insulating sleeve and a vertical cylindrical switch core body encapsulated inside the insulating sleeve,
wherein the switch core body comprises thyristor valve sections, a reactor, driving units, a voltage equalizing assembly section, a structural member and a connecting member; and
after being connected to the driving units on one side of the thyristor valve sections, the thyristor valve sections are arranged, together with the voltage equalizing assembly section, in a space of a lower section of the structural member, an upper section of the structural member is provided with the reactor, and components inside the switch core body are electrically connected through the connecting member.

2. The vertical thyristor switch of claim 1, wherein the thyristor valve section comprises: a thyristor device composed of one layer of thyristors connected in anti-parallel, a jacking tie bar, a jacking nut and a jacking end plate,
the thyristor devices are clamped, through the jacking tie bar and the jacking nut, to form a plurality of thyristor valve sections, and the plurality of thyristor valve sections are connected in series to form a valve string, wherein a stacked opposite triangle structure is formed through connection of the jacking end plates at tops and/or bottoms of adjacent valve sections within the thyristor valve string.

3. The vertical thyristor switch of claim 2, wherein the jacking end plate comprises a plurality of the opposite triangle structures, and each opposite triangle structure fixes one valve section.

4. The vertical thyristor switch of claim 1, wherein the reactor adopts a cylindrical structure and is a self-cooled saturable reactor, a top and a bottom of the reactor adopt a press fit outlet line and an external connection, and an external periphery of the reactor is provided with first umbrella skirt structures.

5. The vertical thyristor switch of claim 4, wherein the reactor is a cylindrical body, and a side surface of the cylindrical body is provided with first umbrella skirt structures having umbrella skirts facing outwards; and a top plate and a bottom plate of the reactor are respectively arranged at a top end and a bottom end of the side surface of the cylindrical body.

6. The vertical thyristor switch of claim 2, wherein the driving unit comprises a plurality of driving assemblies each adopting a pluggable fixed structure, and two thyristors connected in anti-parallel at each layer share one driving assembly.

7. The vertical thyristor switch of claim 6, wherein the driving assembly is a passive driving assembly, and an operation time of the driving assembly has a range from 1 μs to 10 μs.

8. The vertical thyristor switch of claim 6, wherein the pluggable fixed structure is a drawer structure.

9. The vertical thyristor switch of claim 2, wherein the voltage equalizing assembly section comprises a voltage equalizing assembly and a top damping spring of the voltage equalizing assembly; and
the voltage equalizing assemblies are connected, through electrical connection structural members in the connecting member, to respective layers of the thyristors of the thyristor valve section, and a top of the voltage equalizing assemblies is connected to the top damping spring of the voltage equalizing assembly.

10. The vertical thyristor switch of claim 9, wherein the voltage equalizing assembly comprises a plurality of stacked layers of voltage equalizing elements that are connected in series; and
the connecting member comprises metal members, a number of which is same as a number of the voltage equalizing elements, and the voltage equalizing element at each layer is connected, through one metal member, in parallel to a respective layer of the thyristors connected in anti-parallel.

11. The vertical thyristor switch of claim 10, wherein the voltage equalizing assembly comprises only a nonlinear sheet-type resistor; or, the voltage equalizing assembly comprises the nonlinear sheet-type resistor and a small-capacity voltage equalizing capacitor, the voltage equalizing capacitor being mounted in the connecting member between the voltage equalizing assembly and the thyristor device, and a capacitance of the small-capacity voltage equalizing capacitor being determined according to a potential distribution requirement and a leakage current limiting condition, wherein at a normal operating voltage, a leakage current from both the voltage equalizing assembly and the thyristor device is less than 5 mA.

12. The vertical thyristor switch of claim 1, wherein the insulating sleeve comprises a bottom flange, an intermediate insulating member, and a top flange,
wherein the bottom flange and the top flange are respectively arranged at a top end and a bottom end of the intermediate insulating member;
top damping springs of the core body are connected to a top inner surface of the top flange, and a number of the top damping springs is determined according to a height and a weight of the core body; and
the insulating sleeve is an external insulating structure with an inner diameter set according to a size of the switch core body, an expansion space is reserved, according a requirement, inside the insulating sleeve, and the insulating sleeve is filled with nitrogen and airtight as a whole.

13. The vertical thyristor switch of claim 12, wherein the intermediate insulating member adopts a cylindrical structure and is formed using a porcelain material or a composite material, and second umbrella skirt structures having unequal heights are distributed on a side surface of the intermediate insulating member.

14. The vertical thyristor switch of claim 2, wherein force balancing mechanisms are provided, within the valve section, between a bottom of the thyristor device and the jacking end plate and between a top of the thyristor device and the jacking end plate.

15. The vertical thyristor switch of claim 12, wherein the structural member comprises: the top damping springs of the core body, a mid-layer connecting plate, anti-pressure supporting beams and a lower supporting plate,
the anti-pressure supporting beams are arranged around the thyristor valve section and the voltage equalizing assembly section, and have a height not lower than a height of the thyristor valve section and a height of the voltage equalizing assembly section;
the lower supporting plate and the mid-layer connecting plate that are horizontal are respectively arranged at top ends and bottom ends of the anti-pressure supporting beams;
the bottom ends of the anti-pressure supporting beams are connected to an upper surface of the horizontal lower supporting plate, and the top ends of the anti-pressure supporting beams are connected to a lower surface of the horizontal mid-layer connecting plate; and
the reactor is arranged on an upper surface of the mid-layer connecting plate, and a top end of the reactor is connected to the insulating sleeve through the top damping springs of the core body.

16. The vertical thyristor switch of claim 15, wherein the lower supporting plate adopts a plate-like structure and is located at a bottom of the switch core body, and holes are distributed on the lower supporting plate; and a gap is provided between the lower supporting plate and the insulating sleeve; and
the holes of the lower supporting plate and the gap form a channel for flowing of the nitrogen caused by internal discharge, and a discharge outlet of the channel faces the bottom flange.
